(19) United States
(12) Patent Application Publication
(10) Pub. No.: US 2025/0025847 A1
(43) Pub. Date: Jan. 23, 2025

(54) AERATOR ACCESSORY

(71) Applicant: ALEXANDER YEH INDUSTRY CO., LTD., LUKANG CHEN (TW)

(72) Inventor: Ta-Yu Yeh, LUKANG CHEN (TW)

(21) Appl. No.: 18/223,501

(22) Filed: Jul. 18, 2023

(51) Int. Cl. B01F 23/23; B01F 35/40

(52) U.S. Cl. CPC B01F 23/2366; B01F 35/40

(57) ABSTRACT

An aerator accessory has a handle having a main body and a plurality of connecting joints surrounding the main body, a top end and a bottom of each connecting joint respectively connected to a socket with different diameters. Each socket has an opening end and an inner sidewall, and one opening end of at least one of the sockets has a first fastening portion with a plurality of engaging teeth disposed evenly around the opening end. One inner sidewall of at least one of the sockets has a second fastening portion with two opposite parallel tangent planes. One inner sidewall of at least another socket has a third fastening portion comprising at least two fastening grooves on the inner sidewall.

### BACKGROUND OF INVENTION

### Field of Invention

The present invention relates to an aerator accessory.

### Description of Related Art

Usually, an aerator is installed at the water outlet of faucets, water spray guns and other water outlet equipment. The aerator is mainly used to introduce air to break into the water flow, so that the water output contains a lot of air bubbles. When the water output carries a large number of fine air bubble, it can produce the feeling of having a large flow with a small flow, so as to achieve the purpose of saving water.

However, the above conventional structure still has the following problems in practical application: there are many different types and brands of water outlet equipment, so the aerator must match the water outlet equipment with various styles and specification. If each style and specification of the aerator requires a separate tool to be installed, it will cause professional maintenance and installation personnel to purchase a large number of tools, which will result in high cost and inconvenient. In the same situation, it will also make non-professional ordinary people unable to adapt when choosing tools, and may easily buy the wrong person.

Therefore, it is desirable to provide a aerator accessory to mitigate and/or obviate the aforementioned problems.

### SUMMARY OF THE INVENTION

An objective of the present invention is to provide a aerator accessory which is easy to manufacture and providing better steadiness.

In order to achieve the above mentioned objective, a An aerator accessory has a handle having a main body and a plurality of connecting joints surrounding the main body, a top end and a bottom of each connecting joint respectively connected to a socket with different diameters. Each socket has an opening end and an inner sidewall, and one opening end of at least one of the sockets has a first fastening portion with a plurality of engaging teeth disposed evenly around the opening end. One inner sidewall of at least one of the sockets has a second fastening portion with two opposite parallel tangent planes. One inner sidewall of at least another socket has a third fastening portion comprising at least two fastening grooves on the inner sidewall.

Other objects, advantages, and novel features of invention will become more apparent from the following detailed description when taken in conjunction with the accompanying drawings.

### BRIEF DESCRIPTION OF DRAWINGS

FIG. 1 is the perspective view of a preferred embodiment of the present invention.

FIG. 2 is a perspective view of another angle of the preferred embodiment of the present invention.

FIG. 3 is the plan view of the preferred embodiment of the present invention.

FIG. 4 is a sectional view of line A-A in FIG. 3 of the preferred embodiment of the present invention.

FIG. 5 is the section view of line B-B in FIG. 3 of the preferred embodiment of the present invention.

FIG. 6 is a plan view of another angle of the preferred embodiment of the present invention.

FIG. 7 is a schematic drawing of choosing different sockets according to the preferred embodiment in the present invention.

FIG. 8 is a schematic drawing showing the aerator accessory being installed on an aerator according to the preferred embodiment in the present invention.

FIG. 9 is a schematic drawing showing the aerator accessory being uninstalled on an aerator according to the preferred embodiment in the present invention.

FIG. 10 is another schematic drawing showing the aerator accessory being installed on an aerator according to another embodiment in the present invention.

FIG. 11 is another schematic drawing showing the aerator accessory being uninstalled on an aerator according to the another embodiment in the present invention.

### DESCRIPTION OF THE PREFERRED EMBODIMENT

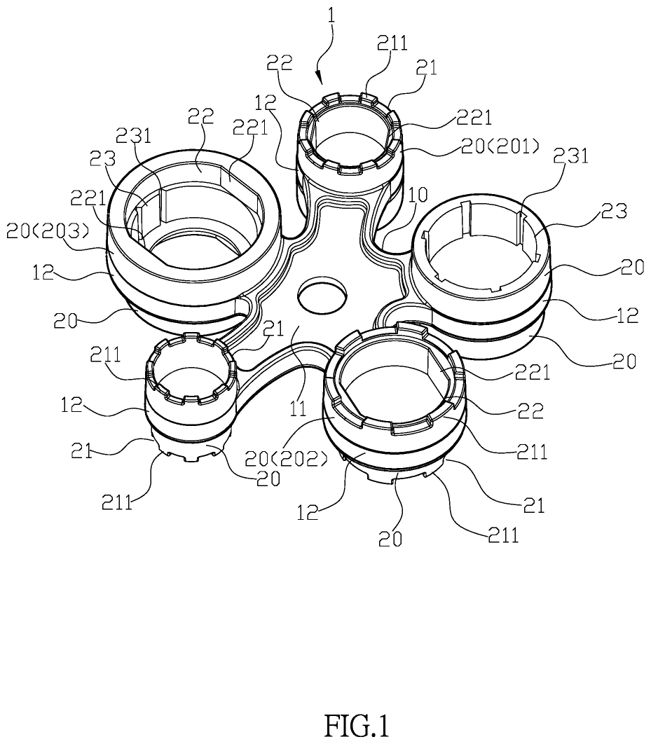

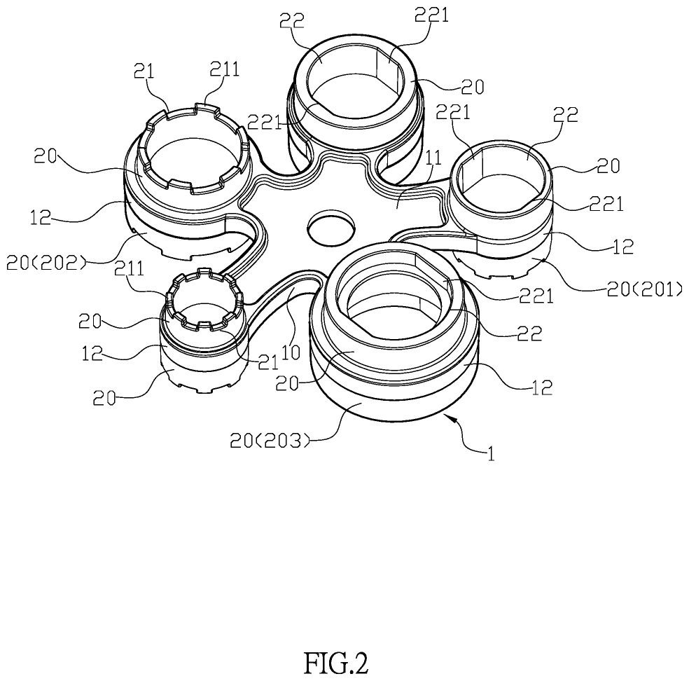

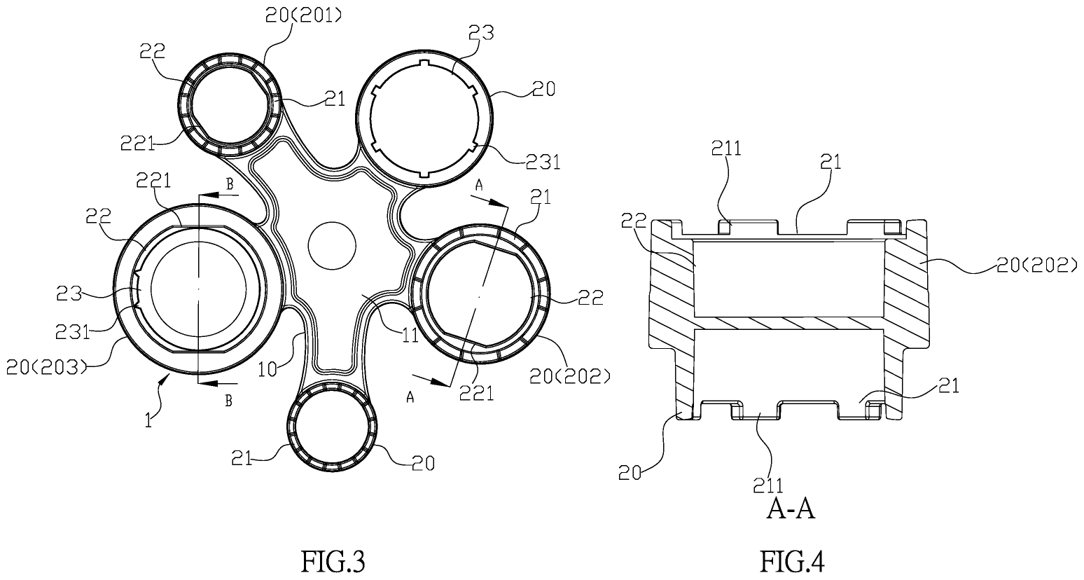

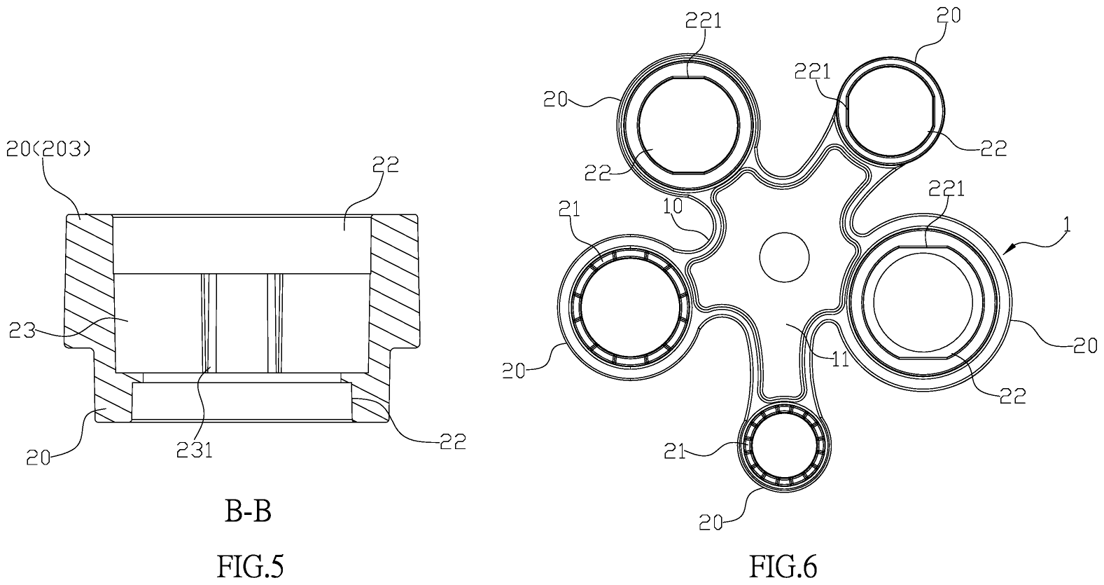

First, please refer to FIG. 1 and FIG. 6. An accessory 1 comprises a handle 10 having a main body 11 and a plurality of connecting joints 12 surrounding the main body 11. A top end and a bottom of each connecting joint 12 respectively connected to a socket 20 with different diameters, such that the accessory 1 can be mounted onto an aerator 2 with different diameters. Each socket 20 comprises an opening end and an inner sidewall, and one opening end of at least one of the sockets 20 has a first fastening portion 21 with a plurality of engaging teeth 211 disposed evenly around the opening end. one inner sidewall of at least one of the socket 20 has a second fastening portion 22 with two opposite parallel tangent planes 221, and one inner sidewall of at least another socket 20 has a third fastening portion 23 comprising at least two fastening grooves 231 on the inner sidewall. Therefore, the accessory 1 can match to different type and specification of aerators 2, and the engaging teeth 211, the tangent planes 221 or the fastening groove 231 engage with the aerator 2. Moreover, the first fastening portion 21 and the second fastening portion 22 or the second fastening portion 22 and the third fastening portion 23 can both being provided on the same socket 20, such that the combinations of the first fastening portion 21 and the second fastening portion 22 or the second fastening portion 22 and the third fastening portion 23 allows the accessory 1 to match various aerators 2.

Moreover, the handle 10 is a plane body.

Furthermore, the aerator accessory 1 further comprises five connecting joints 12 arranged radially around the handle 10.

Moreover, two of the sockets 201, 202 of the accessory 1 have both of the first fastening portion 21 and the second fastening portion 22 (as shown in FIG. 1).

Furthermore, one of the sockets 203 of the accessory 1 have both of the second fastening portion 22 and the third fastening portion 23 (as shown in FIG. 1).

In additional, the first fastening portion 21 comprises six engaging teeth 211 ringed around the opening end.

Alternatively, the first fastening portion 21 comprises eight engaging teeth 211 ringed around the opening end.

Also, the third fastening portion 23 comprises two tapered fastening grooves 231.

Additionally, the third fastening portion comprises a plurality of fastening grooves ringed around the inner peripheral wall. the fastening groove 231.

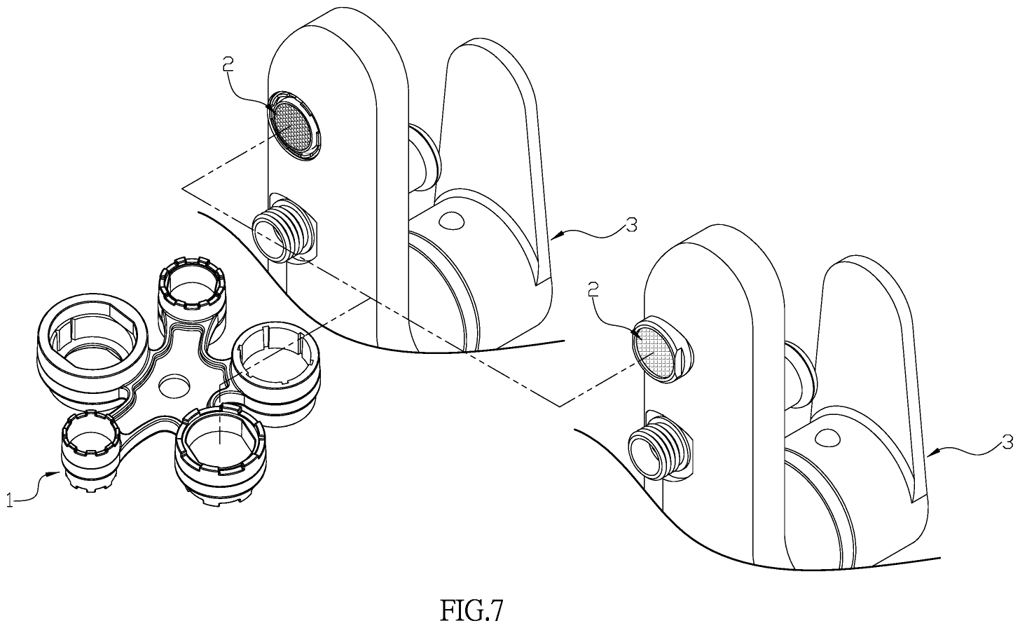

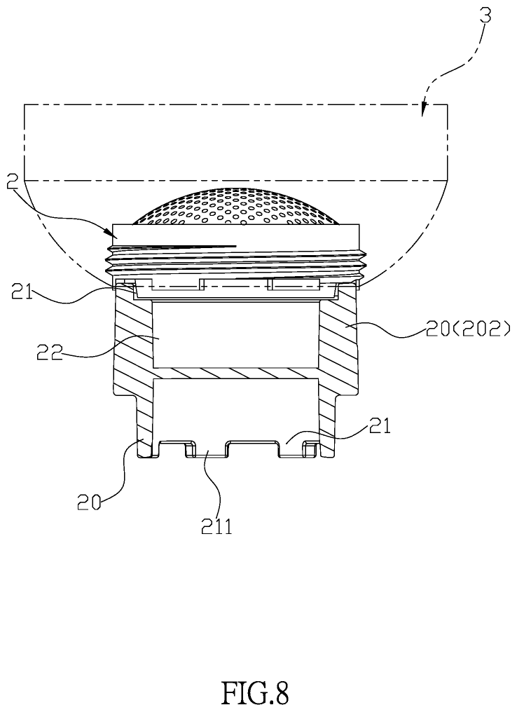

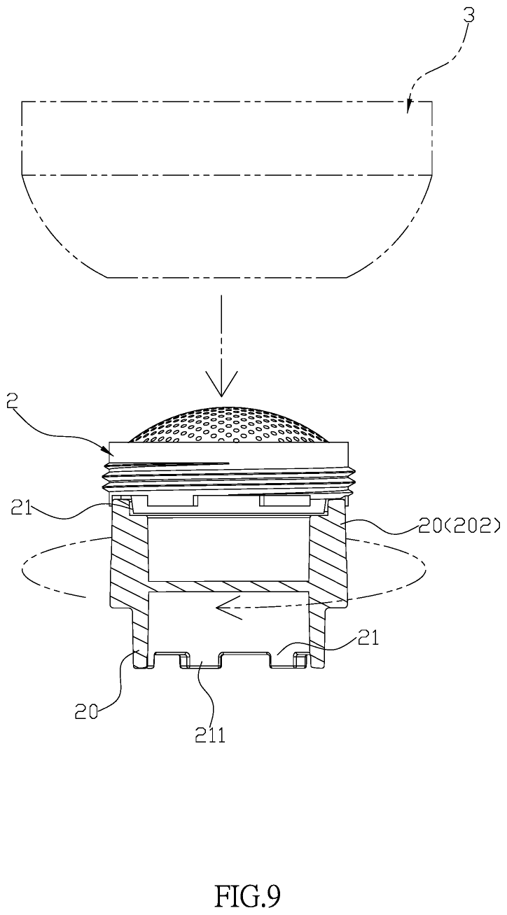

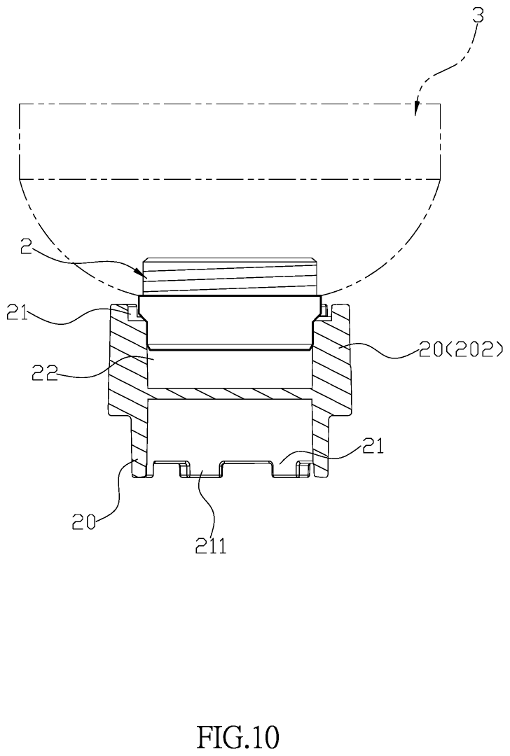

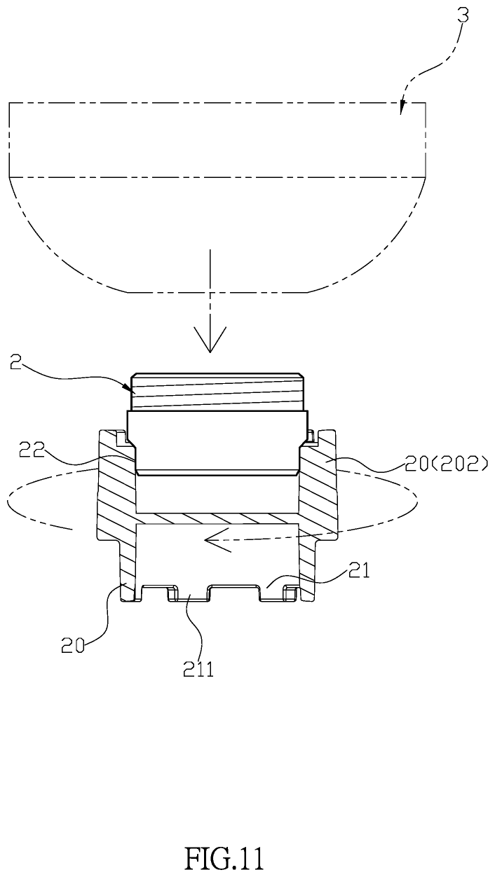

In actual use, depending on the style and specification of the aerator 2, a sockets 20 is selected to fit the aerator 2 (please refer to FIG. 7, FIG. 8 and FIG. 10 at the same time), so that the aerator 2 is capable to engage with the engaging teeth 211, the cutting surface 221 or the fastening groove 231 and turned to be smoothly installed on the water outlet device 3 or removed from the water outlet device 3 (please refer to FIG. 9 and FIG. 11 at the same time). As shown, the same socket 20 has both of the first fastening portion 21 and the second fastening portion 22 or both of the second fastening portion 22 and the third fastening portion 23 at the same time, so the aerator accessory 1 can provide more variety optimized options to apply to more different aerators 2.

The above-mentioned aerator accessory has the following advantages: the aerator accessory can fit onto most of aerators 2 on the market, so that professional technicians no longer need to purchase many different tools which is more economical and relatively convenient to carry and store. Furthermore, non-professional ordinary people can also avoid the phenomenon of being at a loss and buying the wrong tool due to the variety of tools.

Although the present invention has been explained in relation to its preferred embodiment, it is to be understood that many other possible modifications and variations can be made without departing from the spirit and scope of invention as hereinafter claimed.

What is claimed is:

1. An aerator accessory, wherein:
the accessory comprises a handle having a main body and a plurality of connecting joints surrounding the main body, a top end and a bottom of each connecting joint respectively connected to a socket with different diameters; each socket comprising an opening end and an inner sidewall, and one opening end of at least one of the sockets has a first fastening portion with a plurality of engaging teeth disposed evenly around the opening end; one inner sidewall of at least one of the sockets has a second fastening portion with two opposite parallel tangent planes; and one inner sidewall of at least another socket has a third fastening portion comprising at least two fastening grooves on the inner sidewall.

2. The aerator accessory as claimed in claim 1, wherein the handle is a plane body.

3. The aerator accessory as claimed in claim 1 further comprising five connecting joints arranged radially around the handle.

4. The aerator accessory as claimed in claim 1, wherein the first fastening portion comprises six engaging teeth ringed around the opening end of the socket.

5. The aerator accessory as claimed in claim 1, wherein the first fastening portion comprises eight engaging teeth ringed around the opening end.

6. The aerator accessory as claimed in claim 1, wherein the third fastening portion comprises two tapered fastening grooves.

7. The aerator accessory as claimed in claim 1, wherein the third fastening portion comprises a plurality of fastening grooves ringed around the inner peripheral wall.
